(19) United States
(12) Patent Application Publication
(10) Pub. No.: US 2020/0348766 A1
(43) Pub. Date: Nov. 5, 2020

(54) MEDIA MANIPULATION WITH ROTATION OF PORTABLE COMPUTING DEVICE

(71) Applicant: PopSockets LLC, Boulder, CO (US)

(72) Inventors: Altan Nahum, Boulder, CO (US); David B. Barnett, Boulder, CO (US); Randy Yang Chiang, Boulder, CO (US)

(21) Appl. No.: 16/923,468

(22) Filed: Jul. 8, 2020

Related U.S. Application Data
(63) Continuation of application No. PCT/US2018/066696, filed on Dec. 20, 2018.
(60) Provisional application No. 62/614,972, filed on Jan. 8, 2018.

(51) Int. Cl. G06F 3/0346; G11B 27/00; G06F 3/16

(52) U.S. Cl. CPC G06F 3/0346; G06F 3/165; G11B 27/005

(57) ABSTRACT

Portable computing devices, software operating on such devices, and methods are described that utilize rotational data of the device to manipulate media, such as audio, images, and/or video, operating on the device. More specifically, an accelerometer within the device can determine when a user rotates the device and a processing device can thereafter determine one or more manipulation operations to perform on the media based on the rotation. Additional rotational characteristics, such as spin direction, spin speed, spin rate of change, and the like, can further factor into the selection of the one or more manipulation operations.

### CROSS-REFERENCE TO RELATED APPLICATIONS

Priority is claimed to U.S. Provisional Patent Application No. 62/614,972, filed Jan. 8, 2018, the entire contents of which are hereby incorporated herein by reference.

### FIELD OF THE DISCLOSURE

The present disclosure generally relates to software applicagrip accessorytions on a portable client device that implement an accelerometer to receive user inputs.

### BACKGROUND

Many portable devices (e.g., tablets, smart phones) are equipped with an accelerometer that can detect an angular velocity and/or changes to the angular velocity of the device. The accelerometer may be implemented in a variety of applications including orienting the device during GPS navigation, adjusting the screen display based on the orientation of the device, and manipulating controls in games (e.g., steering a car in a racing game).

### SUMMARY

A computer-implemented method for manipulating media based on a rotation event of a client device is described herein that includes playing a media file on a client device, measuring rotation of the client device with an accelerometer of the client device, determining, with a rotation detection module, whether the rotation comprises a rotation event, and manipulating the media file with a manipulation operation corresponding to the rotation event.

In embodiments, the method can further include manipulating the media file with a subsequent manipulation corresponding to a subsequent rotation event.

In embodiments, the method can further include stabilizing an image on a display of the client device during the rotation of the client device.

In embodiments, playing the media file can include playing the media file in response to a rotation event.

In embodiments, manipulating the media file with the manipulation operation can include one or more of: playing the media files backwards in response to one of a clockwise or counterclockwise rotation, controlling playback speed of the media file based on rate of spin of the client device, modulating pitch of the media file, and scratching the media file.

A portable computing device is also described herein that includes an accelerometer that is configured to determine rotation of the portable computing device and a processing device coupled to the accelerometer. The processing device can be configured to play a media file on a client device, measure rotation of the client device with an accelerometer of the client device, determine, with a rotation detection module, whether the rotation comprises a rotation event, and manipulate the media file with a manipulation operation corresponding to the rotation event.

In embodiments, the processing device can be configured to create a modified media file and save the modified media file.

In embodiments, the processing device can be configured to stabilize an image on a display of the client device during the rotation of the client device.

In embodiments, the processing device can be configured to play the media file in response to a rotation event.

In embodiments, the processing device configured to manipulate the media file with the manipulation operation can include one or more of: play the media file backwards in response to one of a clockwise or counterclockwise rotation, control playback speed of the media file based on rate of spin of the client device, modulate pitch of the media file, scratch the media file.

In embodiments, the portable computing device can include an expandable/collapsible grip accessory affixed to a back portion of the portable computing device by a securing element, wherein the expandable/collapsible grip accessory includes a rotating portion that is capable of allowing the portable computing device to rotate around an axis while another portion of the expandable/collapsible grip accessory remains still. In further embodiments, the expandable/collapsible grip accessory can include an cover forming a tapered shape connected to the securing element, the cover capable of extending outward generally along its axis from the portable media player and retracting back toward the portable computing device by collapsing generally along its axis and a foot disposed at the distal end of the cover. In further embodiments, the cover of the grip accessory can include rigid walls interspersed with flexural hinges.

### BRIEF DESCRIPTION OF THE DRAWINGS

The above needs are at least partially met through provision of the computer-implemented method and portable computing device described in the following detailed description, particularly when studied in conjunction with the drawings, wherein:

FIG. 1 is a block diagram of an example computing environment in which the techniques of this disclosure for manipulating media based on rotation of a client device can be implemented in accordance with various embodiments of the present disclosure;

FIG. 2 is a flow chart showing interacting components and steps for altering media in accordance with various embodiments of the present disclosure; and

FIG. 3 schematically illustrates a client device affixed with an expandable/collapsible grip accessory in accordance with various embodiments of the present disclosure.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments. It will further be appreciated that certain actions and/or steps may be described or depicted in a particular order of occurrence while those skilled in the art will understand that such specificity with respect to sequence is not actually required. It will also be understood that the terms and expressions used herein have the ordinary technical meaning as is accorded to such terms and expressions by persons skilled in the technical field as set forth above except where different specific meanings have otherwise been set forth herein.

### DETAILED DESCRIPTION

Portable computing devices, software operating on such devices, and methods are described herein that utilize rotational data of the device to manipulate media, such as audio, images, and/or video, operating on the device. More specifically, an accelerometer within the device can determine when a user rotates the device and thereafter a processing device can determine one or more manipulation operations to perform on the media. Additional rotational characteristics, such as spin direction, spin speed, spin rate of change, and the like, can further factor into the selection of the one or more manipulation operations. The software described herein is particularly suitable for being implemented on a portable computing device affixed with a rotating accessory to enable users to easily rotate the portable computing device for media manipulation.

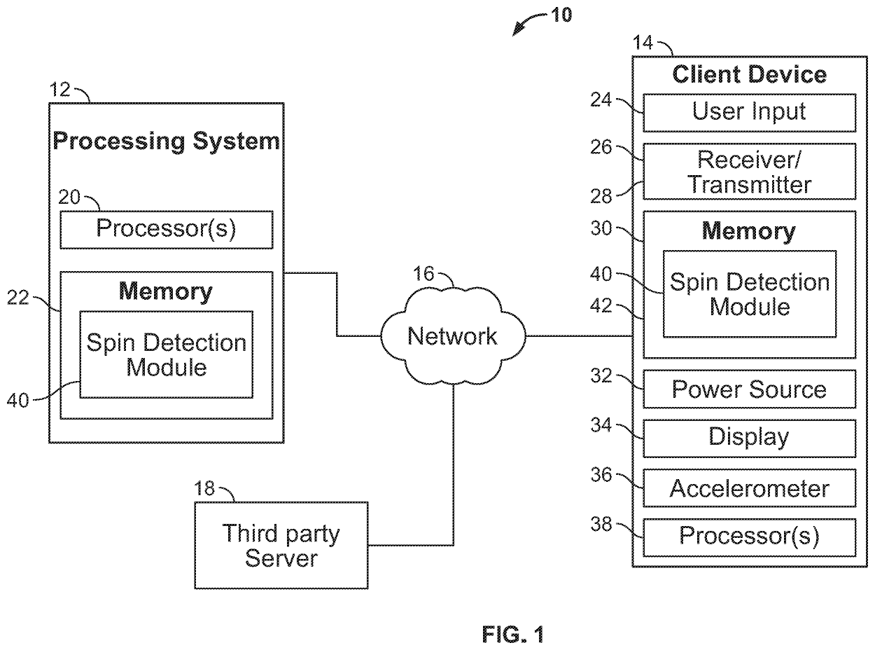

FIG. 1 illustrates one exemplary computing environment 10 in which techniques for manipulating media based on a rotation or spin of a client device may be implemented. In the computing environment 10, a processing system 12 can communicate with various client devices (e.g., client device 14), application servers, web servers, and other devices via a communication network 16, which can be any suitable network, such as the Internet, WiFi, radio, Bluetooth, NFC, etc. The processing system 12 includes one or more servers or other suitable computing devices. The communication network 16 can be a wide-area network (WAN) or a local-area network (LAN), for example, and can include wired and/or wireless communication links. A third-party server 18 can be any suitable computing device that provides web content, applications, storage, etc. to various client devices 14. The content can include media, such as music, video, images, and so forth in any suitable file format.

As illustrated in FIG. 1, the processing system 12 can include one or more processing devices 20 and a memory 22. The memory 22 can include persistent and non-persistent components in any suitable configuration. If desired, these components can be distributed among multiple network nodes. The client device 14 can be any suitable portable computing device, such as a mobile phone, tablet, E-reader, and so forth. The client device 14 can be configured as commonly understood to include a user input 24, such as a touch screen, keypad, switch device, voice command software, or the like, a receiver 26, a transmitter 28, a memory 30, a power source 32, which can be replaceable or rechargeable as desired, a display 34, an accelerometer 36, and a processing device 38 controlling the operation thereof. The accelerometer 36 may be configured to periodically measure rotational characteristics of the device 14, which can include, general rotation, angular velocity, rate of change, direction, and so forth, of the client device 14 and/or determine orientation of the device 14 in a three-dimensional space. The memory 30 can include persistent and non-persistent components. As commonly understood, the components of the device 14 are connected by electrical pathways, such as wires, traces, circuit boards, and the like.

The term processing devices, as utilized herein, refers broadly to any microcontroller, computer, or processor-based device with processor, memory, and programmable input/output peripherals, which is generally designed to govern the operation of other components and devices. It is further understood to include common accompanying accessory devices, including memory, transceivers for communication with other components and devices, etc. These architectural options are well known and understood in the art and require no further description here. The processing devices disclosed herein may be configured (for example, by using corresponding programming stored in a memory as will be well understood by those skilled in the art) to carry out one or more of the steps, actions, and/or functions described herein.

The client device 14 includes a spin detection module 40 stored in the memory 30 as a set of instructions executable by the processing device 38. The spin detection module 40 is configured to analyze measurements from the accelerometer 36 to identify rotational characteristics of the client device 14 and identify any triggering events. If desired, the functionality of the spin detection module 40 also can be implemented as a spin detection module application programming interface (API) 42 stored in the memory 30 that can include any content that may be suitable for the techniques of the current disclosure, which various applications executing on servers and/or client devices can invoke. For example, the API 42 may perform a corresponding action to manipulate media on the client device in response to a rotation event of the client device detected by the spin detection module 40. The spin detection module 40, as set forth below, can invoke the API 42 when necessary, without having to send data to the processing system 12.

By another approach, the memory 22 of the processing system 12 stores instructions that implement a spin detection module 40 configured to receive and transmit data corresponding rotation events and actions measured by the accelerometer 36 of the client device 14 and third party servers 18. The spin detection module 40 may be implemented on the processing system 12, the client device 14 as discussed above, or in any suitable combination for setting and/or implementing the one or more media manipulation actions triggered by a rotation event.

The processing system 12 may receive spin data or measurements from the client device 14 corresponding to the various triggered actions from the client device 14. For example, the third-party server 18 can provide media to be displayed or played on the client device 14 and manipulated using the spin detection module 40 and request that the processing system 12 process spin data received from the client device 14. As another example, the client device 14 can select one or more manipulation actions to be performed in response to a rotation event from a preset list provided by the processing system 12.

The media manipulation actions may include any action that the client device 14 is capable of performing. In an embodiment, a user of the system may be able to preconfigure one or more actions to be performed: when the device rotates, such as in a clockwise and/or counterclockwise direction, based on a speed of rotation, based on an acceleration or slowdown of rotation, and so forth.

In a first form, the media being manipulated according to a given rotation event can be an audio file, whether stored locally or being streamed from the third party server 18. Rotation events detected by the module 40 can cause the API 42 to manipulate the audio according to one or more of: spinning the client device 14 one of clockwise or counterclockwise to cause the audio file to play, stopping rotation to stop or pause playback of the audio file, the other of clockwise or counterclockwise to cause the audio to play backwards, rotating the client device 14 clockwise and/or counterclockwise to scratch or scrub the audio file as with traditional turntables, controlling the speed of playback of the audio file by controlling the rate of spin, modulating a pitch of the audio file by rotating or spinning the client device 14 clockwise or counterclockwise to raise or lower the pitch, and so forth.

If desired, the client device 14 can display an image or video either corresponding to the audio file, such as visualizations, a music video, and so forth, or independent of the audio file being played. The API 42 can further be configured to manipulate the image or video according to the rotation of the client device 14. In a first example, the image or video can be stabilized in a desired orientation while the client device 14 is spinning. The image or video can be shrunk to a central rotation portion so that the image and video is continuously shown during rotation. By another approach, the image or video can have a larger format so that exterior portions the image or video outside of the central rotation portion are shown while the client device 14 rotates through areas corresponding to those exterior portions. In a second example, the image or video can include a swirl, rotating, or spinning effect that corresponds to the rotation of the client device 14, such as slightly slower or faster than the rotation of the client device 14, and that can further include effects corresponding to the audio file.

In another form, the media being manipulated according to a given rotation event can be a video file, which can be any suitable moving image file, such as .avi, .flv, .wmv, .mov, .mp4, a .gif file, and any other suitable file format. In this instance, the rotation event can manipulate the audio of the video, if applicable, as set forth above. Alternatively, or in addition thereto, rotation events detected by the module 40 can cause the API 42 to manipulate the video according to one or more of: spinning the client device 14 one of clockwise or counterclockwise to cause the video to play, stopping rotation to stop or pause playback of the video, the other of clockwise or counterclockwise to cause the video to play backwards, rotating the client device 14 clockwise and/or counterclockwise to scratch or scrub the video to skip forward or backward predetermined amounts, controlling the speed of playback of the video by controlling the rate of spin, and so forth. As with the above discussion, the video can be stabilized in a desired orientation.

It will be understood that the user may be enabled to select which rotation event corresponds to which media manipulation operation and may customize the parameters of the manipulation operation. Such customizations may be entered directly into the client device using the user input 24, at a remote computing device in an account at the processing system 12 and/or third-party server 18, and combinations thereof. For example, when utilizing a rotation for speed playback, the user can set rotational speed ranges to correspond to desired playback speeds. The user can further set the predetermined amount of skipping or scratching that corresponds to a desired angle movement or range.

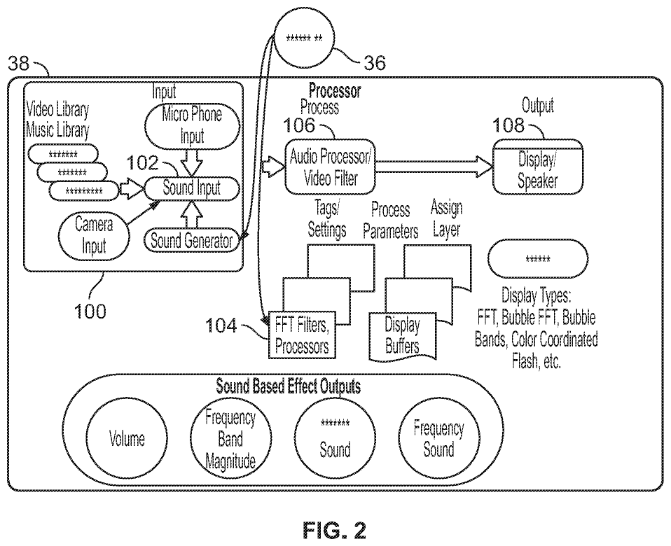

An example flowchart for manipulating a media file is shown in FIG. 2. As illustrated, a user selects 100 a desired media file 102 to manipulate from any desired source, such as a Video/Music library, camera device 39, microphone, sound generator, and so forth. Thereafter, the user can manipulate the media file 102 according to rotation events measured by the accelerometer and detected by the detection module 40 and manipulation operations corresponding to the rotation events. The manipulation operations can include volume, frequency band magnitude, beat, and frequency manipulations. These rotation events and corresponding manipulation operations can be stored settings and parameters 104. The manipulation process creates a modified media file 106 that can be output 108 as desired. The output can include audio output through speakers of the client device 14 or connected devices and display of any image content. If desired, the display can include a visualization output corresponding to the audio file.

Advantageously, the API 42 can further allow a user to save a modified version of the audio and/or video file that includes the manipulations entered by the various rotation events performed by the user. The file can be saved locally in the client device 14 or remotely, such as in the processing system 12 or third-party server 18. By a further approach, the API 42 can include a sharing functionality for a user to share the modified version of the audio and/or video file to remote locations, such as social media sites. This can be achieved through selection of an icon or button of the user input 24.

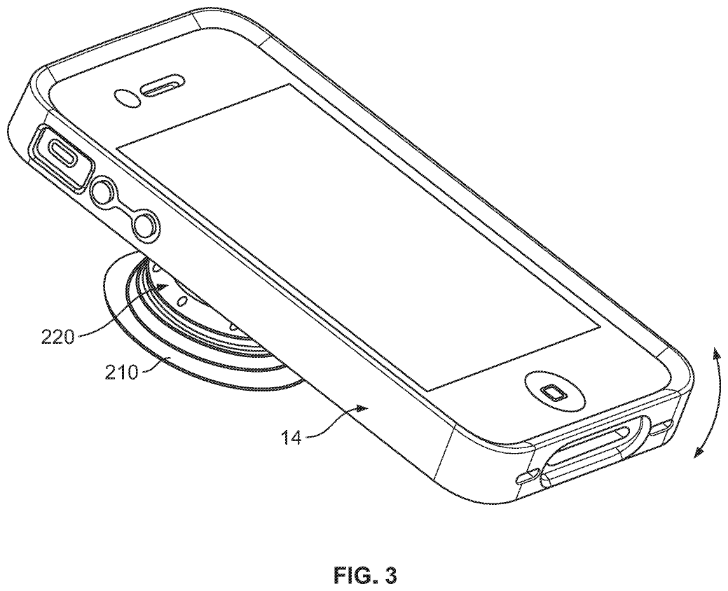

For many approaches, the functionalities described herein can be utilized by a user twisting the client device 14 in a hand, spinning the client device 14 on a surface, and so forth. To further enable a user to easily rotate, spin, and manipulate the rotation of the client device 14, the device 14 may be affixed with an expandable/collapsible grip accessory 210, as illustrated in FIG. 3. FIG. 3 schematically illustrates a client device 14 affixed with a grip accessory 210. The grip accessory 210 of FIG. 3 may include a rotating portion 220, which can include bearings, low-friction couplings, etc., that allows the client device 14 to spin freely relative to the remainder of the grip accessory 210, when the grip accessory 210 is held in a user's hand or placed on a surface, for example. In some instances, the grip accessory 210 of the current disclosure may include, at least in part, an extending grip accessory for a portable media player or portable media player case as disclosed in U.S. Pat. No. 8,560,031, or U.S. Publication No. 2018/0288204, entitled “Spinning Accessory for a Mobile Electronic Device,” the entire disclosures of which are incorporated herein by reference.

The application software described herein can be available for purchase and/or download from any website, online store, or vendor over the communication network 16. Alternatively, a user can download the application onto a personal computer and transfer the application to the client device 14. When operation is desired, the user runs the application on the client device 14 by a suitable selection through the user input 24.

The following additional considerations apply to the foregoing discussion. Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of various embodiments. This description should be read to include one or at least one and the singular also includes the plural unless it is obvious that it is meant otherwise.

Those skilled in the art will recognize that a wide variety of modifications, alterations, and combinations can be made with respect to the above described embodiments without departing from the scope of the invention, and that such modifications, alterations, and combinations are to be viewed as being within the ambit of the inventive concept.

1. A computer-implemented method for manipulating media based on a rotation event of a client device, the method comprising:
playing a media file on a client device;
measuring rotation of the client device with an accelerometer of the client device;
determining, with a rotation detection module, whether the rotation comprises a rotation event;
manipulating the media file with a manipulation operation corresponding to the rotation event.

2. The computer-implemented method of claim 1, wherein manipulating the media file comprises at least one of: (a) increasing a speed of playing the media file, (b) decreasing a speed of playing the media file, (c) reversing the direction of playing the media file, (d) starting the playing of the media file, (e) stopping the playing of the media file, and/or (f) altering the media file by applying a filter or overlaying a second media file.

3. The computer-implemented method of claim 1, further comprising manipulating the media file with a subsequent manipulation corresponding to a subsequent rotation event.

4. The computer-implemented method of claim 1, further comprising stabilizing an image on a display of the client device during the rotation of the client device.

5. The computer-implemented method of claim 1, wherein playing the media file comprises playing the media file in response to a rotation event.

6. The computer-implemented method of claim 1, wherein manipulating the media file with the manipulation operation comprises playing the media files backwards in response to one of a clockwise or counterclockwise rotation.

7. The computer-implemented method of claim 1, wherein manipulating the media file with the manipulation operation comprises controlling playback speed of the media file based on rate of spin of the client device.

8. The computer-implemented method of claim 1, wherein manipulating the media file with the manipulation operation comprises modulating pitch of the media file.

9. The computer-implemented method of claim 1, wherein manipulating the media file with the manipulation operation comprises scratching the media file.

10. The computer-implemented method of claim 1, wherein the media file comprises a video file.

11. The computer-implemented method of claim 1, wherein the media file comprises an audio file.

12. The computer-implemented method of claim 1, wherein manipulating the media file with the manipulation operation comprises creating a modified media file, and further comprising saving the modified media file.

13. A portable computing device comprising:
an accelerometer configured to determine rotation of the portable computing device;
a processing device coupled to the accelerometer, the processing device configured to:
play a media file on a client device;
measure rotation of the client device with an accelerometer of the client device;
determine, with a rotation detection module, whether the rotation comprises a rotation event;
manipulate the media file with a manipulation operation corresponding to the rotation event.

14. The portable computing device of claim 13, wherein the processing device is further configured to stabilize an image on a display of the client device during the rotation of the client device.

15. The portable computing device of claim 13, wherein the processing device configured to play the media file comprises the processing device configured to play the media file in response to a rotation event.

16. The portable computing device of claim 13, wherein the processing device configured to manipulate the media file with the manipulation operation comprises the processing device configured to perform one or more of:
play the media file backwards in response to one of a clockwise or counterclockwise rotation, control playback speed of the media file based on rate of spin of the client device, modulate pitch of the media file, scratch the media file.

17. The portable computing device of claim 13, wherein the processing device configured to manipulate the media file with the manipulation operation comprises the processing device configured to create a modified media file, and wherein the processing device is further configured to save the modified media file.

18. The portable computing device of claim 13, further comprising an expandable/collapsible grip accessory affixed to a back portion of the portable computing device by a securing element, wherein the expandable/collapsible grip accessory includes a rotating portion that is capable of allowing the portable computing device to rotate around an axis while another portion of the expandable/collapsible grip accessory remains still.

19. The portable computing device of claim 18, wherein the expandable/collapsible grip accessory further comprises:
an cover forming a tapered shape connected to the securing element, the cover capable of extending outward generally along its axis from the portable media player and retracting back toward the portable computing device by collapsing generally along its axis; and
a foot disposed at the distal end of the cover.

20. The portable computing device of claim 18, wherein the cover of the grip accessory comprises rigid walls interspersed with flexural hinges.
